(19) United States
(12) Patent Application Publication
(10) Pub. No.: US 2011/0005385 A1
(43) Pub. Date: Jan. 13, 2011

(54) TWO PORT - THREE POSITION ACTUATOR

(76) Inventors: Hung Truong, Panorama City, CA (US); Angel Ching, Montebello, CA (US); Tarig Latif, Downey, CA (US)

Correspondence Address: LEON D. ROSEN;FREILICH, HORNBAKER & ROSEN, Suite 1220, 10960 Wilshire Blvd., Los Angeles, CA, 90024, US

(21) Appl. No.: 12/833,771

(22) Filed: Jul. 9, 2010

Related U.S. Application Data
(60) Provisional application No. 61/270,500, filed on Jul. 9, 2009.

(51) Int. Cl. F15B 15/17

(52) U.S. Cl. 91/417 R

(57) ABSTRACT

An hydraulic actuator with a housing having two ports (A, C) that selectively receive pressured fluid to move a piston (12) to a forward position (12F) or to a rearward position (12R), wherein the piston can be moved to a third, or neutral position (12N) by applying equally pressured fluid to both ports. A pusher (24) that lies in the same housing cavity as the piston, is pushed forward by pressured fluid applied to the second port (C), and the pusher pushes the piston forwardly. The pusher moves forward until the pusher abuts a housing surface (52), at which point the piston lies in the third position (12N).

### CROSS-REFERENCE

Applicant claims priority from U.S. Provisional patent application Ser. No. 61/270,500 filed Jul. 9, 2009.

### BACKGROUND OF THE INVENTION

Hydraulic actuators commonly have a plurality of ports for receiving pressured fluid from a pressured source to move a piston between selected positions. For example, two ports A and C may be provided, with the piston moving to a rearward position when the pressured fluid is applied to port A and with the piston moving to a forward position when the pressured fluid is applied to port C. A third port may be provided, which can receive the pressured fluid to move the piston to a third position, such as a neutral position that lies between the forward and rearward positions. The pressured fluid is commonly at the same pressure for all ports, and a valve connected to the pressured fluid source is operated to select which of the three ports is to receive the pressured fluid.

It would be desirable if the actuator could be simplified to increase reliability and to reduce cost and complexity. One way would be by reducing the number of ports and by simplifying the valve.

### SUMMARY OF THE INVENTION

In accordance with one embodiment of the invention, a simplified actuator is provided, of the type that uses a valve to connect a pressured fluid source to selected port(s) of a housing that contains a piston, to move the piston between a plurality of positions within the housing. The piston can be moved between three positions along an axis, but the housing requires only two ports and the valve that connects the pressured source to the ports connects to only the two ports.

The piston can be moved to front or rear positions by operating the valve to apply pressured fluid to the first port A or to the second port B. The piston also can be moved to a neutral position that lies between the front and rear positions, by applying the pressured fluid to both the first and second ports A and C. The actuator includes a pusher that pushes the piston from a rearward position to the neutral position when pressured fluid is applied to both ports.

The pusher has a rear-facing first face that is exposed only to fluid applied through the second port C. The area of the pusher first face that is exposed to fluid from port C, plus the area of a rear-facing face of the piston exposed to fluid from port C, is greater than an area of the piston exposed to fluid applied at the first port A. Thus, when fluid is applied to both ports A and C, the piston and pusher move forward, until the pusher abuts a housing surface and the piston lies in the neutral position.

The novel features of the invention are set forth with particularity in the appended claims. The invention will be best understood from the following description when read in conjunction with the accompanying drawings.

### BRIEF DESCRIPTION OF THE DRAWINGS

FIG. 1 is an isometric view of the actuator of the invention, shown connected to a valve that connects to a pressured fluid source.

FIG. 2 is a sectional view of the actuator, with the piston lying halfway between its rear position and its neutral position.

### DESCRIPTION OF THE PREFERRED EMBODIMENTS

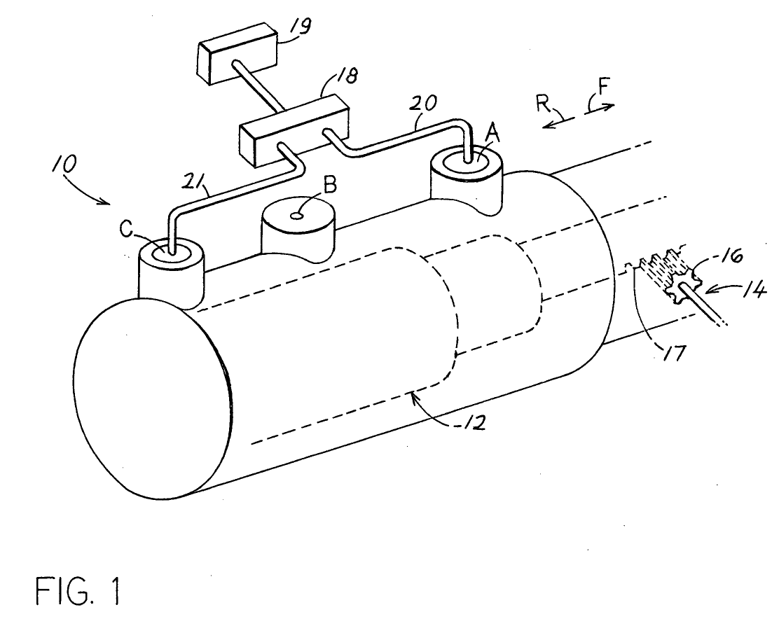

FIG. 1 shows an actuator 10 which includes a piston 12 that moves in forward F and rearward R directions to drive a control 14. The particular control 14 includes a pinion gear 16 which is rotated in a selected one of two directions by a rack 17 that is attached to the piston. The particular actuator is designed for use in undersea hydrocarbon production, where the piston can be made to produce large forces by applying high pressure hydraulic fluid to selected ports labeled A and C. A valve 18 which receives pressured fluid from a pressured fluid source 19, is connected by pipes 20, 21 to the actuator ports

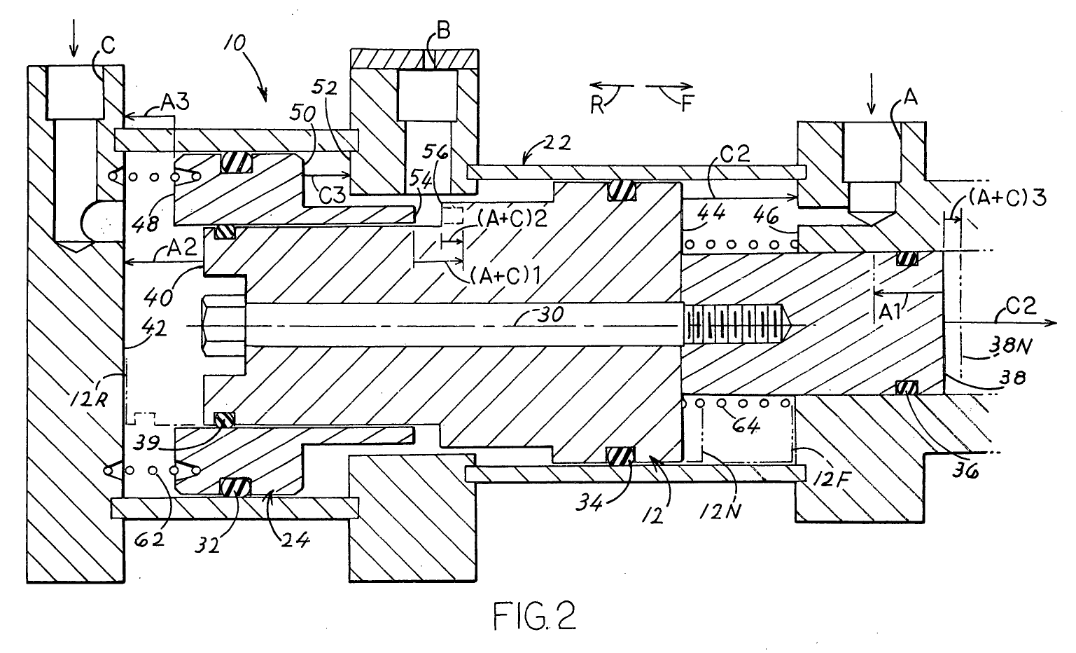

In the following description, applicant indicates movement in FIG. 2 by arrows in the figure such as A1, A2, etc. that indicate that the movement was caused by pressure in the corresponding port A. Applicant also uses terms such as C1 to indicate movement caused by pressure applied to port C, and uses terms such as (A+C)1, (A+C)2, etc. to indicate movement caused by pressure, applied to both ports A and C.

FIG. 2 shows that the actuator includes a housing 22 and two primary movable parts in the housing, including the piston 12 and a pusher 24 that is shown spaced by distance A3 from housing surface 42. Both primary movable parts are movable along the housing axis 30 and are sealed to the housing by O-ring seals 32, 34, 36 and 39. The piston is movable between three primary positions, including a forward position 12F wherein the piston has moved forward F by the distance C2. The piston also can move to a rearward position 12R by moving rearward by distance A2 (from the position shown in solid lines in FIG. 2). The piston also can move to a neutral position at 12N by moving forward by distance (A+C)2. These three positions are controlled by the application of fluid pressure (e.g. of hydraulic fluid) to selected ports A and C. In the event that no fluid pressure is applied to either port, the piston is biased towards the neutral position 12N. The piston and pusher are symmetrical and concentric about the axis 30.

When pressured hydraulic fluid is applied to only port A, the piston 12 is pushed rearward R by the pressure, and its rear face 40 moves by the distance A2 against a housing rear wall 42. When pressured hydraulic fluid is applied only to port C, the piston is pushed forward F by the pressure, and a piston front surface 44 moves forward by the distance C2 against a housing front wall 46 while its toothed rack 17 also moves forward by the distance C2. In addition, the pusher 24 moves forward by the distance C3, at which it is stopped by a surface or face 52 of the housing.

The piston also can be moved to a neutral position that is close to the position illustrated in solid lines in FIG. 2, by applying equal hydraulic fluid pressure simultaneously to both ports A and C. The fluid pressure at port C moves the pusher 24 forwardly until its forward-facing surface 50 abuts a housing surface 52. At this position of the pusher, a pusher extension front end 54 has moved forward by distance (A+C)1 where it has pushed a piston surface 56 slightly forward so the piston has moved forward by the distance (A+C)2 to the piston neutral position 12N.

With equal pressure applied at both ports A and C, the fluid pressure at port A presses against piston front-facing surface 44 and tends to move the piston rearward. However, the fluid pressure applied to port C not only urges the pusher 24 forward, but also urges the piston rearward-facing surface 40 forwardly. When the pusher has moved forward by a small distance against the piston rearward-facing surface 56, the piston is urged in opposite directions by fluid at the two ports. The area of the rearward-facing piston surface 40 plus the area of the rearward-facing pusher surface 48 is greater than the area of the forward-facing piston surface 44, so the piston and pusher move forward F until the pusher is stopped by a housing rearward-facing surface 52.

Applicant notes that the area of piston surface 44 exposed to the pressure in port A is greater than the area of the piston rear end 40, so when equal pressure is applied to both ports A and C, the piston is pushed rearward R with a moderate force and is held in position by the pusher front end 54 which abuts the piston surface 56. The port B allows the flow of air into or out of the indicated space.

Applicant can provide one spring 62 or two springs 62, 64, or no spring. With one spring 62, the piston moves from the rearward position 12R to the neutral or “fail-safe” position 12N if there is no hydraulic fluid pressure. In that case, a spring 62 moves the pusher forward until its forward-facing face or surface 50 abuts the housing surface 52 and the piston has moved forward to the neutral position 12N. A similar spring at 64 can be provided that also moves the piston rearward from the forward position to the neutral position if there is no hydraulic fluid pressure. The second spring pushes with less force than the first spring. It is also possible to provide neither spring 62 nor 64, so the piston can be pushed manually (e.g. by moving pinion 16 of FIG. 1) to a desired position.

Thus, the invention provides a hydraulic actuator having a housing that requires only two ports for receiving pressured fluid from a valve, while controlling a piston to lie at a selected one of three piston positions. When fluid pressure is applied to only one of the ports, the piston moves to an extreme rearward or extreme forward position. When equal fluid pressure is applied to both ports, the piston moves to an intermediate, or third, or neutral position. The actuator includes a pusher that is exposed only to fluid applied to one of the ports, such as the second port C. When fluid pressure is applied to both ports A and C, the piston tends to move rearward. However, the pusher moves forward and the pusher pushes the piston forward. When the pusher abuts a housing surface, it cannot move the piston any further forward, and at that pusher position the piston is in its third position.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A hydraulic actuator comprising:
a housing;
a piston that is slideable in forward and rearward directions in the housing, said piston having a first forward-facing piston surface (44) and a first rearward-facing piston surface (40);
a pusher (24) that is slideable in forward and rearward directions in the housing, said pusher having a first forward-facing pusher surface (50) and having a rearward-facing pusher surface (48);
said housing having a first port (A) that is coupled to said first piston surface (44), so when pressured fluid is applied only to said first port (A) said pressured fluid moves said piston rearward to a rear position (12R);
said housing having a second port (C) that is coupled to said pusher rear-facing surface (48) and said piston rear-facing surface (40), so when pressured fluid is applied only to said second port (C) said pressured fluid moves said pusher and said piston forward to a forward position (12F);
said piston and pusher surfaces being chosen so when equal pressured fluid is applied to said first and second ports (A, B), said pusher is urged forward to abut a rearward-facing surface (52) of said housing and said piston is moved to a neutral position (12N).

2. The actuator described in claim 1 including:
a spring that urges said pusher forwardly, said pusher having a surface (54) that pushes said piston forwardly to said neutral position, and said housing rearward surface (52) limits forward movement of said pusher.

3. The actuator described in claim 1 wherein:
said pusher has a forward-facing first pusher surface (50), and said housing has a rearward-facing surface (52) located in the path of said first pusher surface and positioned to engage said first pusher surface when said pusher reaches said neutral position.

4. The actuator described in claim 3 wherein:
said pusher has a second forward-facing surface (54) and said piston has a rearward facing second surface (56) lying in the path of said pusher second forward-facing surface so said pusher pushes said piston forward as said pusher approaches said neutral position.

5. A hydraulic actuator which controls movement of a piston along a piston axis (30) within a housing (22) wherein said housing has a first port (A) for receiving pressured fluid with said first port coupled to a piston front-facing face (44) to move the piston rearward (R) to a rear position (12R), said housing has a second port (C) for receiving pressured fluid with said second port coupled to a piston rear-facing face (40) to move the piston forward (F) toward a front position (12F), and said piston moves to a neutral position between said rear and forward positions when equal fluid pressures are applied to said first and second ports (A, C), wherein:
said housing has a front-facing housing face (42), and said housing has first and second rear-facing housing faces (46, 52);
a pusher (24) which has a rear-facing pusher face (48) and a front-facing pusher first face (50), said rear-facing pusher face (48) being coupled to said second port (C) so pressured fluid applied to said second port (C) moves said pusher forward (F) until said pusher front-facing first face (50) abuts said second front-facing housing face (52), and said piston having a rear-facing face portion (56) in line with a pusher front-facing face portion (54);
the area of said piston front-facing face (44) is greater than the area of said piston rear-facing face (40) but less than the combined area of said piston rear-facing face (40) plus the area of said rear-facing pusher face (48).

6. The actuator described in claim 5 wherein:
said pusher has a forward-projecting part (54) that projects forward of said pusher first face (50), with said forward-projecting part lying in line with said piston rear-facing face portion (56).
